(19) United States
(12) Patent Application Publication
(10) Pub. No.: US 2026/0031688 A1
(43) Pub. Date: Jan. 29, 2026

(54) STATOR COIL MANUFACTURING APPARATUS AND METHOD

(71) Applicant: Enedym Inc., Hamilton (CA)

(72) Inventors: Jonathan Lau, Hamilton (CA); Berker Bilgin, Hamilton (CA)

(21) Appl. No.: 19/345,340

(22) Filed: Sep. 30, 2025

Related U.S. Application Data
(63) Continuation of application No. PCT/CA2023/050713, filed on May 25, 2023.

(51) Int. Cl. H02K 15/043

(52) U.S. Cl. CPC H02K 15/0431

(57) ABSTRACT

A concentrated coil manufacturing apparatus for transfer to a stator tooth is provided. The apparatus may comprise a spindle and a coil transfer tool. The spindle may comprise a spindle winding machine mount and a transfer tool mount. The coil transfer tool may extend from a spindle mounting end to a distal end; and may have a coil carrier and a crown. The coil carrier may extend from the crown towards the spindle mounting end. The spindle mounting end of the coil transfer tool may be removably securable to the spindle at the transfer tool mount. When the coil transfer tool is removably secured to the spindle, the coil transfer tool and the spindle may collectively define upper and lower coil endcap mounts that are closed in that each endcap mount includes a proximal portion defined by the spindle joined to a distal portion defined by the coil transfer tool.

### FIELD

This document relates to stator coil manufacturing apparatus and methods and specifically, to concentrated coil manufacturing apparatus and methods for transfer to a stator tooth.

### BACKGROUND

The stator coils used in electric motors can typically include either of two types of winding: distributed winding or concentrated winding. In distributed winding, the stator coil is wound over at least two stator teeth. In concentrated winding, the stator coil is wound over a single stator tooth to form a concentrated coil. The winding turns are wound together in series to form one multi-turn concentrated coil. All of the winding turns have the same magnetic axis.

Concentrated coils can be used in different types of electric motors. For example, a concentrated coil can be wound around each stator tooth of a switched reluctance motor (SRM). When the concentrated coils belonging to different stator teeth are energized sequentially, the rotor teeth follow the excited stator teeth creating rotation of the rotor.

The concentrated coils for stator teeth may be manufactured using needle winding or spindle winding techniques. In needle winding techniques, the concentrated coil can be manufactured by winding a wire directly onto a stator tooth. In spindle winding techniques, the concentrated coil can be first wound externally using a spindle or linear winding machine. The wound coil can then be transferred to a stator tooth. Spindle winding techniques can be faster and less expensive compared with needle winding techniques for manufacturing concentrated coils for stator teeth.

### SUMMARY

The following summary is provided to introduce the reader to the more detailed discussion to follow. The summary is not intended to limit or define any claimed or as yet unclaimed invention. One or more inventions may reside in any combination or sub-combination of the elements or process steps disclosed in any part of this document including its claims and figures.

According to some aspects, a concentrated coil manufacturing apparatus for transfer to a stator tooth is provided. The apparatus may comprise a spindle and a coil transfer tool. The spindle may comprise a spindle winding machine mount and a transfer tool mount. The coil transfer tool may extend from a spindle mounting end to a transfer tool distal end. The coil transfer tool may have a coil carrier and a crown. The coil carrier may extend from the crown towards the spindle mounting end. The spindle mounting end of the coil transfer tool may be removably securable to the spindle at the transfer tool mount. When the coil transfer tool is removably secured to the spindle at the transfer tool mount, the coil transfer tool and the spindle may collectively define upper and lower coil endcap mounts that are closed in that each endcap mount includes a proximal portion defined by the spindle joined to a distal portion defined by the coil transfer tool. When the coil transfer tool is separated from the spindle the upper and lower coil endcap mounts may be opened in that the distal portions of the upper and lower coil endcap mounts are separated from the proximal portions of the upper and lower coil endcap mounts respectively to define a coil dismounting end on the coil transfer tool.

According to some aspects, a method of manufacturing a concentrated coil for a stator tooth is provided. The method may comprise: securing upper and lower coil endcaps to upper and lower coil endcap mounts, the upper and lower coil endcap mounts defined collectively by a coil transfer tool and a spindle, the coil transfer tool removably secured to the spindle; anchoring wire to the spindle; after said anchoring, rotating the spindle while feeding the wire to wind the wire around the upper and lower coil endcaps thereby forming a concentrated coil around the coil transfer tool, the concentrated coil including a plurality of turns of the wire and the upper and lower coil endcaps; detaching the coil transfer tool from the spindle thereby opening the upper and lower coil endcap mounts, the concentrated coil remaining mounted to the coil transfer tool; abutting the stator tooth with the coil transfer tool that is carrying the concentrated coil; and sliding the concentrated coil off of the coil transfer tool onto the stator tooth that is abutting the coil transfer tool.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a schematic illustration of a concentrated coil manufacturing apparatus, in accordance with an embodiment.

FIG. 2 is a perspective view of components of the apparatus of FIG. 1.

FIG. 3 is a perspective view of the apparatus of FIG. 1, when a coil transfer tool of the apparatus is removably secured to a spindle of the apparatus.

FIG. 4 is a perspective view of the apparatus of FIG. 1, when the coil transfer tool is detached from the spindle.

FIG. 5 is a perspective view of the coil transfer tool of the apparatus of FIG. 1.

FIG. 6A is a top perspective view of a coil endcap of the apparatus of FIG. 1.

FIG. 6B is a bottom perspective view of the coil endcap of FIG. 6A.

FIG. 7 is another perspective view of the apparatus of FIG. 1, showing the coil transfer tool of the apparatus removably secured to the spindle of the apparatus.

FIG. 8 is a flowchart illustrating an example method of manufacturing a concentrated coil for a stator tooth.

FIG. 9 is a perspective view of a stator tooth abutting the coil transfer tool of the apparatus of FIG. 1.

### DETAILED DESCRIPTION

Numerous embodiments are described in this application and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

As used herein and in the claims, two or more parts are said to be “coupled”, “connected”, “attached”, “joined”, “affixed”, or “fastened” where the parts are joined or operate together either directly or indirectly (i.e., through one or more intermediate parts), so long as a link occurs. As used herein and in the claims, two or more parts are said to be “directly coupled”, “directly connected”, “directly attached”, “directly joined”, “directly affixed”, or “directly fastened” where the parts are connected in physical contact with each other. As used herein, two or more parts are said to be “rigidly coupled”, “rigidly connected”, “rigidly attached”, “rigidly joined”, “rigidly affixed”, or “rigidly fastened” where the parts are coupled so as to move as one while maintaining a constant orientation relative to each other. None of the terms “coupled”, “connected”, “attached”, “joined”, “affixed”, and “fastened” distinguish the manner in which two or more parts are joined together.

Further, although method steps may be described (in the disclosure and/or in the claims) in a sequential order, such methods may be configured to work in alternate orders. In other words, any sequence or order of steps that may be described does not necessarily indicate a requirement that the steps be performed in that order. The steps of methods described herein may be performed in any order that is practical. Further, some steps may be performed simultaneously.

As used herein and in the claims, a group of elements are said to ‘collectively’ perform an act where that act is performed by any one of the elements in the group, or performed cooperatively by two or more (or all) elements in the group.

As used herein and in the claims, a first element is said to be “received” in a second element where at least a portion of the first element is received in the second element unless specifically stated otherwise.

Some elements herein may be identified by a part number, which is composed of a base number followed by an alphabetical or subscript-numerical suffix (e.g., 112a, or 1121). Multiple elements herein may be identified by part numbers that share a base number in common and that differ by their suffixes (e.g., 1121, 1122, and 1123). All elements with a common base number may be referred to collectively or generically using the base number without a suffix (e.g., 112).

As used herein and in the claims, “up”, “down”, “above”, “below”, “upwardly”, “vertical”, “elevation”, “upper”, “lower” and similar terms are in reference to a directionality generally aligned with (e.g., parallel to) gravity. The terms “distal”, “proximal” and similar terms are in reference to a directionality generally that is transverse (e.g., perpendicular) to gravity. However, none of the terms referred to in this paragraph imply any particular alignment between elements. For example, a first element may be said to be “vertically above” a second element, where the first element is at a higher elevation than the second element, and irrespective of whether the first element is vertically aligned with the second element.

Generally, the spindle or linear winding machines used for manufacturing concentrated coils are automated winding machines. Different coil parameters (e.g., wire size, wire layout, number of turns per coil) can be provided as inputs to the winding machine. Based on the input parameters, the winding machine can wind the coil on a bobbin or a tooling.

In spindle winding techniques using a bobbin, the bobbin along with the wound coil can be removed from the winding machine after the winding process is completed. The bobbin along with the wound coil is then inserted into a stator during motor assembly process. That is, the bobbin becomes a permanent component of the motor. The bobbin can provide electrical insulation between the current carrying coil and the stator core that is typically at ground potential. However, the slot area occupied by the bobbins can reduce the slot fill factor.

In spindle winding techniques using a tooling, the coil can be wound on a tooling that is formed in the shape of the stator tooth. After the winding process is completed, the wound coil can be removed from the winding machine and removed from the tooling. The wound coil is then transferred to the stator tooth during motor assembly process. It may be necessary to maintain the form/shape of the wound coil as it is removed from the winding machine and the tooling and is transferred to the stator tooth. For example, if the wound coil collapses during the transfer process, the coil cross-section can decrease and may not be transferable onto the stator tooth. As another example, if the wound coil loosens during the transfer process, the coil cross-section can increase, which may reduce the slot fill factor and efficiency of the motor.

To maintain the form/shape of the wound coil on removal and transfer, self-bonding wires (containing a bonding agent) may be used during spindle winding techniques using a tooling. The self-bonding wire may first be wound on a tooling to form a coil. Next, an electrical current may be applied to the self-bonding wire of the wound coil. The applied current can increase the temperature of the wound coil due to heating generated by resistive losses in the self-bonding wire. This can soften the bonding agent present on the insulation layer of the self-bonding wire. After the applied electric current is removed, the temperature of the wound coil can decrease causing the bonding agent to be cured whereby the self-bonding wires bond with each other. After this bonding process is completed, the wound coil can maintain its shape/form. The wound coil can be removed from the winding machine and the tooling and transferred to the stator tooth while maintaining its shape/form.

Manufacturing stator coils using self-bonding wires and the bonding process can increase cost and manufacturing complexity, and impact the performance of the motor. Self-bonding wires can be more expensive compared with equivalent non-self-bonding wires because the self-bonding wires are typically specialized wires that have an insulation layer containing a bonding agent. Self-bonding wires may have lower market availability compared with non-self-bonding wires and such supply constraints can increase the cost and complexity of the manufacturing process. Additionally, the bonding process may require specialized equipment that applies the electrical current and this may further increase the manufacturing cost.

A self-bonding wire may also have a lower thermal rating compared with a non-self-bonding wire. Using self-bonding wires can therefore impact motor performance because the motor may need to be operated at lower temperatures.

The disclosed apparatus and methods can provide concentrated coils manufactured using spindle winding techniques. This may enable lower manufacturing cost associated with the spindle winding techniques (compared with needle winding techniques). The concentrated coils can be manufactured without using bobbins or self-bonding wires resulting in potentially lower cost, manufacturing complexity, and improved motor performance.

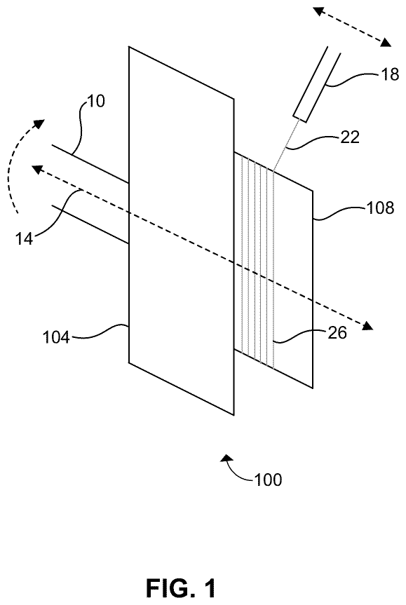

Referring now to FIG. 1, shown therein is a schematic illustration of a concentrated coil manufacturing apparatus 100, in accordance with an embodiment. As shown, apparatus 100 may include a spindle 104 and a coil transfer tool 108.

Spindle 104 can be removably mounted to a spindle winding machine. Coil transfer tool 108 can be removably secured to spindle 104. FIG. 1 shows spindle 104 mounted to a winding machine 10 and coil transfer tool 108 secured to the spindle 104.

Winding machine 10 can rotate spindle 104 (along with coil transfer tool 108 secured to spindle 104) around a rotational axis 14. Winding machine 10 can include a wire guide 18 that is movable linearly in a direction parallel to rotational axis 14. Wire guide 18 can feed a wire 22 to form a concentrated coil 26. Wire 22 can include non-self-bonding wire.

To manufacture concentrated coil 26, one end of wire 22 may be anchored to spindle 104. Next, spindle 104 and coil transfer tool 108 can be rotated by winding machine 10 while feeding wire 22 from the linearly moving wire guide 18 to form concentrated coil 26 around coil transfer tool 108. After the winding is completed, coil transfer tool 108 can be detached from spindle 104 while concentrated coil 26 remains mounted on coil transfer tool 108. Next, a stator tooth can be abutted to coil transfer tool 108 and concentrated coil 26 can be slid off of coil transfer tool 108 onto the stator tooth.

The disclosed apparatus 100 can be used to manufacture concentrated coils without requiring bobbins. Accordingly, higher slot fill factors (i.e., higher ratio of the cross-sectional area occupied by copper wire inside the stator slot to the total amount of available space in the bare slot) may be achieved for the motor compared with coils that are wound around bobbins. This may provide the motor with greater torque, or allow a smaller motor to achieve the same torque, all else being equal. Coil transfer tool 108 can provide support to the wound concentrated coil 26 during removal from the winding machine and transfer to the stator tooth. Accordingly, the disclosed apparatus 100 can enable maintaining the shape/form of the wound coil during removal from the winding machine and transfer to a stator tooth without using self-bonding wires. Avoiding the usage of self-bonding wires can enable lower manufacturing cost. Additionally, non-self-bonding wires typically have higher thermal rating, which can improve motor performance by enabling higher operating temperatures.

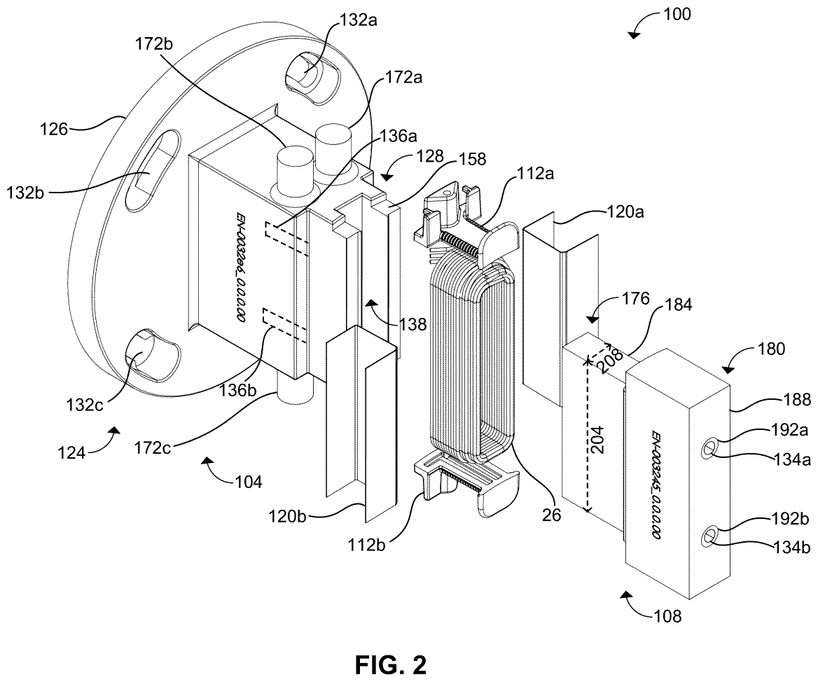

Referring now to FIG. 2, shown therein is a perspective view of components of apparatus 100, in accordance with an embodiment. In the illustrated embodiment, apparatus 100 includes a spindle 104, a coil transfer tool 108, a pair of coil endcaps 112 (upper coil endcap 112a and lower coil endcap 112b), a pair of slot liners 120a and 120b. A concentrated coil 26 may be wound using a spindle winding machine (e.g., winding machine 10 (FIG. 1)) and apparatus 100.

Spindle 104 may be made using any suitable material that provides sufficient mechanical strength and rigidity. For example, spindle 104 may be made using metal (e.g., steel, such as stainless steel, brass, aluminum, or metal alloys). Spindle 104 may include a spindle winding machine mount 124 and a transfer tool mount 128.

Spindle winding machine mount 124 can have any design suitable for removably mounting spindle 104 to a spindle winding machine (e.g., winding machine 10 (FIG. 1)). For example, spindle winding machine mount 124 may include a machine interface 126 that abuts a corresponding interface of the spindle winding machine. For example, machine interface 126 may be formed as a disc as shown, or may have another design (e.g., a rectangular block shape) sized and shaped to be removably mounted to the corresponding interface of the spindle winding machine.

Spindle winding machine mount 124 may include one or multiple apertures (e.g., 132a-132c shown in FIG. 2) sized and positioned to accommodate fasteners (not shown) and align with fastener receptacles (e.g., threaded holes) in the spindle winding machine. This allows threaded fasteners (e.g., screws) to be inserted through apertures 132 and tightened in the fastener receptacles of the spindle winding machine to removably fasten spindle winding machine mount 124 to the spindle winding machine. In some embodiments, spindle winding machine mount 124 may not include any apertures for fasteners and spindle winding machine mount 124 may be secured to the spindle winding machine using other mechanisms, e.g., using clamps.

In alternative embodiments, apparatus 100 is non-removably secured to a spindle winding machine. For example, apparatus 100 may be permanently connected to a spindle winding machine (e.g., by adhesive, rivets, or welds) or integrally formed with a component of the spindle winding machine. This may provide a more secure and lasting connection between apparatus 100 and the spindle winding machine.

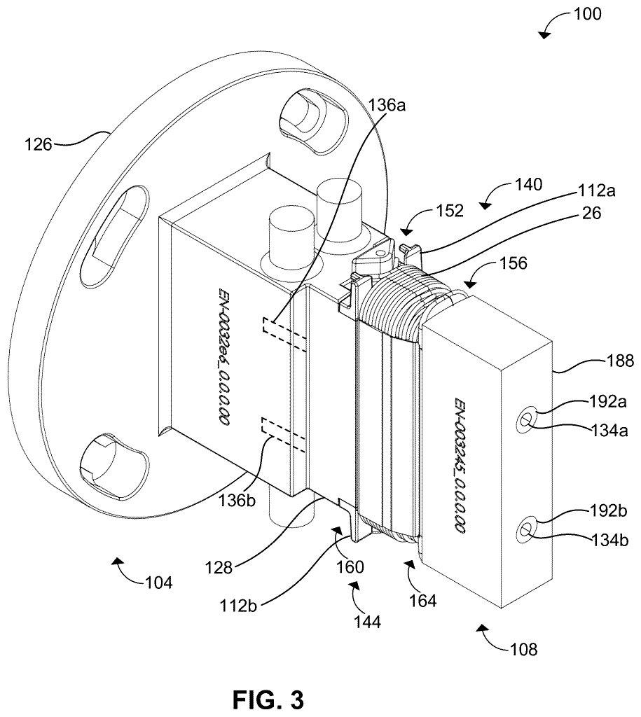

Transfer tool mount 128 can have any design suitable for removably securing coil transfer tool 108 to spindle 104. Referring now to FIG. 3, shown therein is a perspective view of apparatus 100 when coil transfer tool 108 is removably secured to spindle 104 at transfer tool mount 128, in accordance with an embodiment. Coil transfer tool 108 and spindle 104 can collectively define upper coil endcap mount 140 and lower coil endcap mount 144.

The transfer tool mount 128 may be located on a distal end of spindle 104, and be configured to accommodate a connection with a spindle mounting end 176 (FIG. 2) of coil transfer tool 108. For example, transfer tool mount 128 may include one or more fastener receptacles (e.g., threaded or unthreaded bores) for connection with a fastener (e.g., threaded fastener 134, such as a screw) that removably secures coil transfer tool 108 to spindle 104. Transfer tool mount 128 may include any number of fastener receptacles 136 (e.g., 1 to 10 fastener receptacles 136) in any arrangement. In the illustrated example, transfer tool mount 128 includes two fastener receptacles 136a and 136b positioned to accept two corresponding fasteners 134a and 134b respectively, for removably securing coil transfer tool 108 to spindle 104. In some cases, a greater number of fastener receptacles 136 (e.g., 4 to 6) may provide greater flexibility to accommodate different fastener patterns or allow for connecting with more fasteners for a more secure connection. Fastener receptacles 136 may have threaded or unthreaded holes depending on the type of fasteners used for securing coil transfer tool 108 to spindle 104.

In some embodiments, transfer tool mount 128 may not include any fastener receptacles. For example, transfer tool mount 128 may include other mechanism(s) to removably secure coil transfer tool 108 to spindle 104, e.g., clamps that enable quick-release operation.

In some embodiments, transfer tool mount 128 may have a recessed portion 138, as shown in FIG. 2. Recessed portion 138 may have any suitable design to receive spindle mounting end 176 of coil transfer tool 108 for greater stability. In other embodiments, transfer tool mount 128 may not have a recessed portion 138.

Referring now to FIGS. 2 and 3, concentrated coil 26 may be wound around coil endcaps 112 (e.g., upper coil endcap 112a and lower coil endcap 112b) using a spindle winding machine. Coil endcaps 112 may be held in place during the winding process by situating the coil endcaps on endcap mounts. For example, upper coil endcap 112a may be situated on upper coil endcap mount 140 and lower coil endcap 112b may be situated on lower coil endcap mount 144. As described in further detail herein below, when the endcap mounts are closed, the endcaps along with the wound wire, may be immobilized on coil transfer tool 108 during winding to form concentrated coil 26. When the endcap mounts are open, the endcaps, along with the wound concentrated coil 26, can be slid off coil transfer tool 108 onto an abutting stator tooth.

The endcap mounts may have any design suitable to provide a closed configuration in which they can immobilize a mounted end cap, and an open position in which they can permit a mounted endcap to be removed. As shown, upper coil endcap mount 140 may include a proximal portion 152 and a distal portion 156. Proximal portion 152 can be defined by spindle 104 and distal portion 156 can be defined by coil transfer tool 108. When coil transfer tool 108 is secured to spindle 104, upper coil endcap mount 140 may be closed (as illustrated in FIG. 3) and proximal portion 152 can be joined to distal portion 156. FIG. 3 shows upper coil endcap 112a removably mounted at upper coil endcap mount 140.

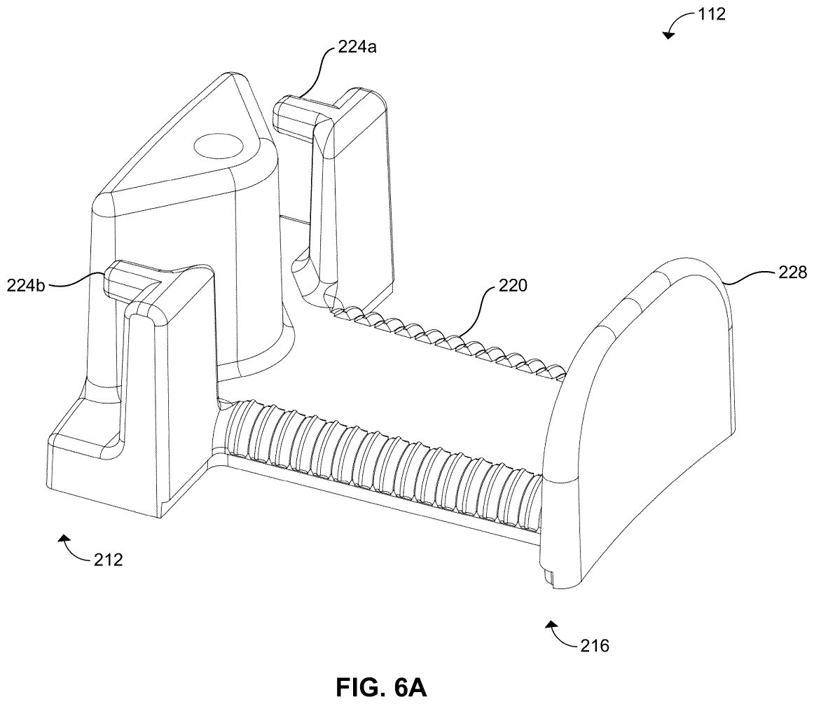

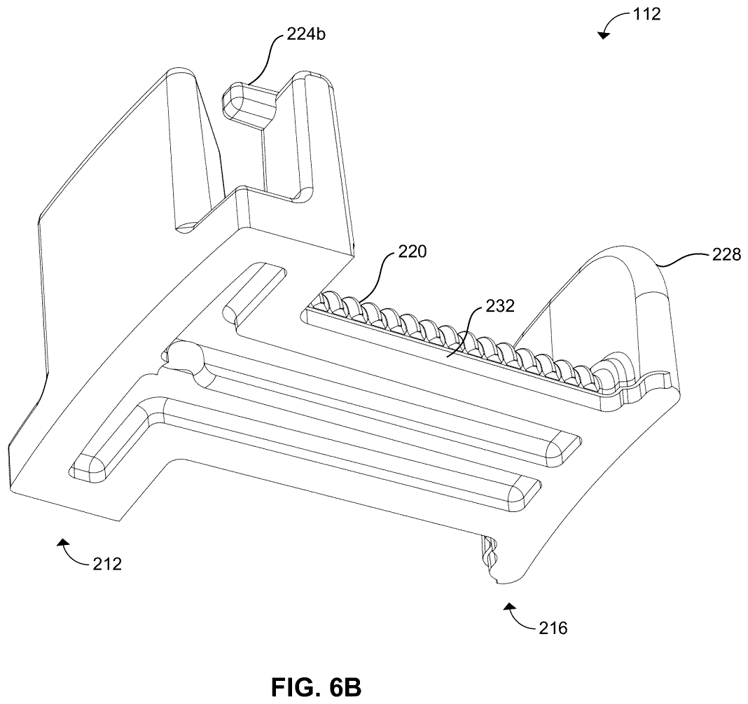

Referring back to both FIGS. 2 and 3, spindle 104 may include any suitable design to define proximal portion 152. In the illustrated example, spindle 104 includes a recessed seat 158 that accommodates the shape of upper coil endcap 112a thereby enabling a proximal end 212 (FIGS. 6A and 6B) of upper coil endcap 112a to be mountable (e.g., seated) at proximal portion 152. Upper coil endcap 112a may be secured in its position by applying a compressive force between coil transfer tool 108 and spindle 104. No fasteners may be required to secure upper coil endcap 112a to spindle 104 and this may enable faster manufacturing time of concentrated coils using apparatus 100. In some embodiments, proximal portion 152 comprises only an end wall of upper coil endcap mount 140 against which coil transfer tool 108 may apply compressive force to upper coil endcap 112a.

In alternative embodiments, spindle 104 may include a flat, non-recessed seat to define proximal portion 152. This may reduce the manufacturing complexity of spindle 104. Spindle 104 may include fastener aperture(s) (e.g., threaded or non-threaded holes, not shown) that secure the proximal end of upper coil endcap 112a to spindle 104 at proximal portion 152. The fasteners may provide a more secure mounting of upper coil endcap 112a to spindle 104, which may allow for faster winding speeds and/or less robust endcap design.

Lower coil endcap mount 144 may include a proximal portion 160 and a distal portion 164. Proximal portion 160 can be defined by spindle 104 and distal portion 164 can be defined by coil transfer tool 108. When coil transfer tool 108 is secured to spindle 104, lower coil endcap mount 144 may be closed (as illustrated in FIG. 3) and proximal portion 160 can be joined to distal portion 164. FIG. 3 shows lower coil endcap 112b removably mounted at lower coil endcap mount 144.

Spindle 104 may include any suitable design to define proximal portion 160. For example, spindle 104 may include a recessed seat (not visible in FIGS. 2 and 3) that accommodates the shape of lower coil endcap 112b thereby enabling a proximal end 212 (FIGS. 6A and 6B) of lower coil endcap 112b to be mountable (e.g., seated) at proximal portion 160. Lower coil endcap 112b may be secured in its position by applying a compressive force between coil transfer tool 108 and spindle 104. No fasteners may be required to secure lower coil endcap 112b to spindle 104 and this may enable faster manufacturing time of concentrated coils using apparatus 100. In some embodiments, proximal portion 160 comprises only an end wall of lower coil endcap mount 144 against which coil transfer tool 108 may apply compressive force to lower coil endcap 112b.

In alternative embodiments, spindle 104 may include a flat, non-recessed seat to define proximal portion 160. This may reduce the manufacturing complexity of spindle 104. Spindle 104 may include fastener aperture(s) (e.g., threaded or non-threaded holes, not shown) that secure the proximal end of lower coil endcap 112b to spindle 104 at proximal portion 160. The fasteners may provide a more secure mounting of lower coil endcap 112b to spindle 104, which may allow for faster winding speeds and/or less robust endcap design.

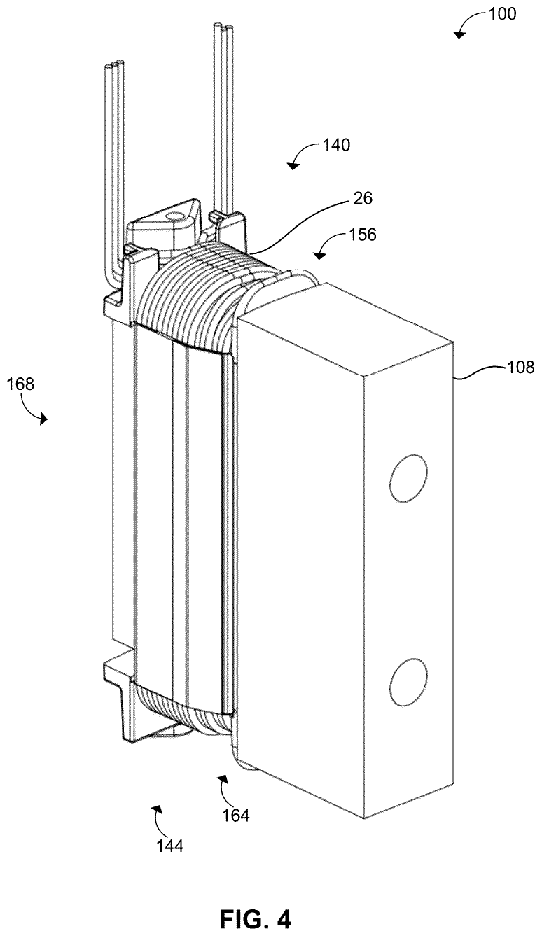

Referring now to FIG. 4, shown therein is a perspective view of apparatus 100 when coil transfer tool 108 is detached from the spindle, whereby upper coil endcap mount 140 and lower coil endcap mount 144 are open. When upper coil endcap mount 140 and lower coil endcap mount 144 are opened, distal portion 156 is separated from proximal portion 152 (FIG. 3) and distal portion 164 is separated from proximal portion 160 (FIG. 3) to define a coil dismounting end 168 on coil transfer tool 108. Coil dismounting end 168 may be sized and shaped to permit a wound concentrated coil (e.g., concentrated coil 26), along with the coil endcaps, to be dismounted (i.e., removed) from coil transfer tool 108 onto a stator tooth by abutting coil dismounting end 168 to the stator tooth, and sliding the wound concentrated coil 26 across coil dismounting end 168 onto the stator tooth.

Referring back to FIG. 2, spindle 104 may have any suitable number of wire wrapping posts (e.g., 1 to 4). A lower number of wire wrapping posts may reduce the manufacturing complexity of spindle 104 while a higher number of wire wrapping posts may provide greater flexibility during manufacturing of concentrated coils using apparatus 100. The illustrated embodiment includes four wire wrapping posts 172, three of which (wire wrapping posts 172a-172c) are visible in FIG. 2.

Wire wrapping posts 172 may have any suitable design to provide anchoring for a wire. For example, wire wrapping posts 172 may be formed as pillar structures as shown in FIG. 2. In other examples, wire wrapping posts 172 may have other structures, e.g., a hook, loop, or clamp.

During the winding process, a first end of a wire (e.g., wire 22 of FIG. 1) may be anchored to a wire wrapping post (e.g., wire wrapping post 172a). A concentrated coil may then be formed by rotating spindle 104 and coil transfer tool 108 while feeding wire from a linearly moving wire guide (e.g., wire guide 18 of FIG. 1). After the winding process is completed, the wire may be anchored to a second wire wrapping post (e.g., wire wrapping post 172b) and cut off from the remaining wire in the winding machine.

In some embodiments, wire wrapping posts 172 may also be used to create intermediate leads of the winding wire. For example, the wire may be routed out of the coil during the winding process, wrapped around the wire wrapping posts and then routed back into the coil to include additional turns of the wire in the concentrated coil. The wrapped wire between the wire wrapping posts may then be cut forming pairs of start and end leads.

Spindle 104 may be formed as a unitary structure including wire wrapping posts 172. In some embodiments, wire wrapping posts 172 may be manufactured as separate components that can be permanently or removably attached to spindle 104 (e.g., screwed into mounting holes of the spindle, or welded to spindle 104). This may reduce the manufacturing complexity of spindle 104.

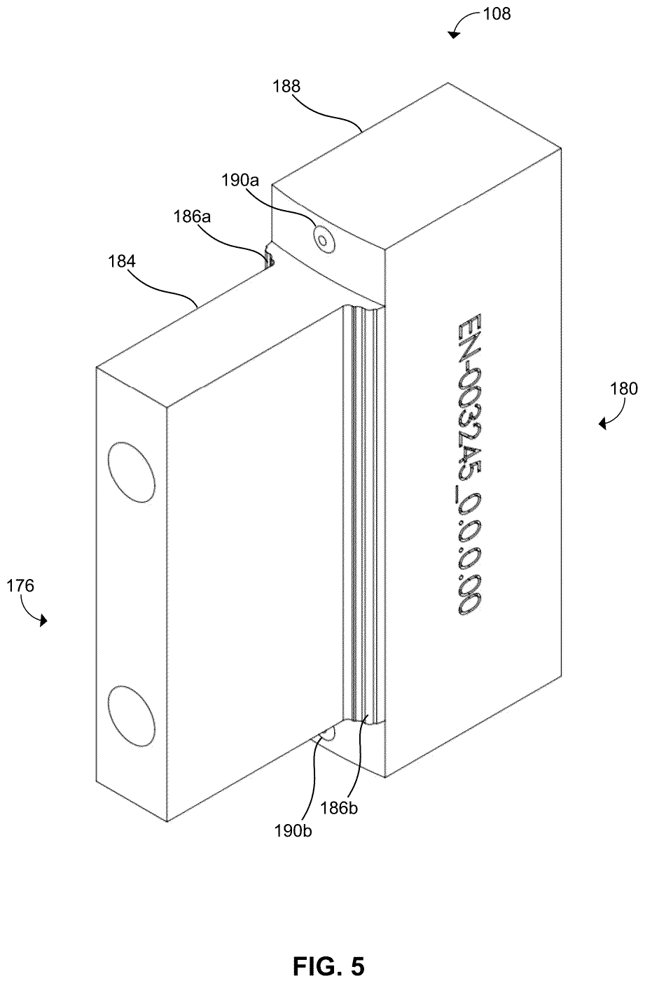

Reference is now made to FIGS. 2 and 5. FIG. 5 shows a perspective view of coil transfer tool 108. Coil transfer tool 108 may be made using any suitable material that provides sufficient mechanical strength and rigidity. For example, coil transfer tool 108 may be made using metal (e.g., steel, such as stainless steel, brass, aluminum, or metal alloys).

Coil transfer tool 108 may extend from spindle mounting end 176 to a transfer tool distal end 180. Coil transfer tool 108 may include a coil carrier 184 and a crown 188.

Spindle mounting end 176 may be removably securable to spindle 104 at transfer tool mount 128. In some embodiments, coil transfer tool 108 may include through holes 192a and 192b for fasteners that secure coil transfer tool 108 to spindle 104. Coil transfer tool 108 may include any suitable number of through holes 192, for example (1 to 6). A larger number of through holes 192 may enable usage of greater number of fasteners to provide a more secure connection between coil transfer tool 108 and spindle 104. A smaller number of through holes 192 may reduce manufacturing cost of the apparatus and may reduce the manufacturing time of concentrated coils using the apparatus.

The holes 192 may be threaded or non-threaded holes depending on the type of fasteners used. In other embodiments, transfer tool mount 128 may not include any through holes 192 for fasteners and transfer tool mount 128 may be secured to spindle 104 using other mechanisms, e.g., using clamps that enable quick-release operation.

Coil carrier 184 may extend from crown 188 towards spindle mounting end 176. Coil carrier 184 may have any suitable design to enable transfer of the wound coil to a stator tooth and to provide mechanical support to the coil during the winding process and during transfer from the winding machine to the stator tooth. For example, coil carrier 184 may have a shape that matches the stator tooth. Each of the length 204 and width 208 of coil carrier 184 may be approximately equal (e.g., 0% to 10% larger) to the length and width respectively of the stator tooth. A coil carrier 184 with tighter dimension matching with the stator tooth (e.g., 0 to 1%) may enable higher slot fill factors but may increase manufacturing cost/complexity of the apparatus. A coil carrier 184 with less stringent dimension matching (e.g., 1% to 5%) may reduce manufacturing cost/complexity of the apparatus.

In the illustrated example, coil carrier 184 includes contoured surfaces 186a and 186b extending along the length of coil carrier 184 at an end proximal to crown 188. Contoured surfaces 186 may aid in the coil winding process by matching the profile of the concentrated coil as multiple turns of wire are wound around the upper and lower coil endcaps to form the concentrated coil. In some embodiments, coil carrier 184 does not include contoured surfaces 186. This may reduce manufacturing cost/complexity of the apparatus.

Crown 188 may have any suitable design to serve as a handle (for human or machine handling) when the concentrated coil is mounted to coil carrier 184. For example, the crown may serve as a handle when coil transfer tool 108 is separated from spindle 104 and during transfer of the concentrated coil from coil transfer tool 108 to a stator tooth. In the illustrated example, crown 188 is formed as a rectangular block shape. In other examples, crown 188 may be formed as other shapes, e.g., a disc shape.

Crown 188 may be used as a handle by a human operator when coil transfer tool 108 is separated from spindle 104 and during transfer of the concentrated coil from coil transfer tool 108 to a stator tooth. In some embodiments, crown 188 may be used as a handle by a machine (e.g., robot) operator. Crown 188 may include any suitable fixtures that enable handling by robotic arms, tools etc. Crown 188 may also include locating features that may be used by the perception systems of a robot operator to automatically align coil transfer tool 108 with the stator tooth during transfer of the concentrated coil.

In the illustrated example, crown 188 includes protrusions 190a and 190b at an end proximal to coil carrier 184. Protrusions 190 may have any suitable design to provide an interference fit with corresponding elements at distal portions of the upper and lower coil endcaps. When the upper and lower coil endcaps are mounted at corresponding upper and lower coil endcap mounts respectively to begin the coil winding process, protrusions 190 can enable secure positioning of the upper and lower coil endcaps. In some embodiments, crown 188 may include a greater number of protrusions 190 (e.g., 3 to 6) to provide a more secure positioning of the upper and lower coil endcaps. In other embodiments, crown 188 may include a single protrusion 190 or may not include any protrusions 190 to reduce the manufacturing cost/complexity of the apparatus.

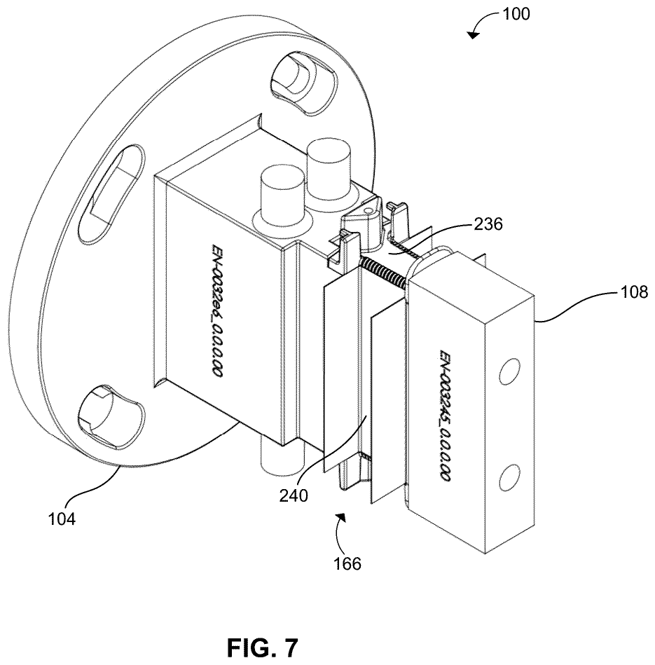

Reference is now made to FIGS. 2-4, 6A, 6B, and 7. FIGS. 6A and 6B show top and bottom perspective views respectively of a coil endcap 112, in accordance with an embodiment. FIG. 7 shows a perspective view of apparatus 100, when coil transfer tool 108 is removably secured to spindle 104 and before a coil has been wound around the coil endcaps.

Coil endcap 112 may be manufactured using a molding or machining process. Coil endcap 112 may be made using any suitable material that provides sufficient rigidity to support the concentrated coil and provides electrical insulation between the wound wire and the stator tooth that the concentrated coil is transferred to. For example, coil endcap 112 may be made using a suitable polymer, or non-ferromagnetic metal depending on the insulation requirements and operational specifications (including temperature ratings) of the motor. Coil endcap 112 may be electrically insulating (e.g., with a resistivity greater than 10⁴ ohm-m at 20° C.). For example, coil endcap 112 may have a resistivity in a range from 10¹⁰ to 10¹⁶ ohm-m at 20° C. Higher resistivity can provide greater insulation between the coil and the stator tooth.

Coil endcap 112 may have a proximal end 212 and a distal end 216. When coil transfer tool 108 is removably secured to spindle 104 at transfer tool mount 128, proximal end 212 and distal end 216 of the upper coil endcap 112a are removably mountable (e.g., seated) at proximal portion 152 and distal portion 156 respectively of upper coil endcap mount 140. Similarly, proximal end 212 and distal end 216 of lower coil endcap 112b are removably mountable (e.g., seated) at proximal portion 160 and distal portion 164 respectively of lower coil endcap mount 144.

Proximal end 212 may have any suitable design to enable coil endcap 112 to be removably mounted to proximal portions 152 and/or 160. In the illustrated example, proximal end 212 may be shaped to mate with the recessed seat of spindle 104 at proximal portions 152 and 160. Similarly, distal end 216 may have any suitable design to enable coil endcap 112 to be removably mounted to distal portions 156 and/or 164. In the illustrated example, distal end 216 may be shaped to mate with the recessed seat of coil transfer tool 108 at distal portions 156 and 164.

When coil transfer tool 108 is removably secured to spindle 104 at transfer tool mount 128 such that endcap mounts 140, 144 are closed, upper coil endcap 112a and lower coil endcap 112b may be removably mounted to upper coil endcap mount 140 and lower coil endcap mount 144 respectively to form a first pair of opposing sides of a coil body 166. For example, a side 236 of the first pair of opposing sides is shown in FIG. 7. A wire can be wound around coil body 166 to form the concentrated coil.

When coil transfer tool 108 is separated from spindle 104, whereby the upper and lower coil endcap mounts 140, 144 are opened, proximal ends 212 of upper coil endcap 112a and lower coil endcap 112b are separated from proximal portions 152 and 160 respectively. Distal ends 216 of upper coil endcap 112a and lower coil endcap 112b may remain mounted on distal portions 156 and 164 respectively. When the concentrated coil is transferred from coil transfer tool 108 to a stator tooth, distal ends 216 of upper coil endcap 112a and lower coil endcap 112b may be moved (e.g., slid) off of the distal portions 156 and 164 respectively. The wound concentrated coil including upper coil endcap 112a and the lower coil endcap 112b can be transferred from coil transfer tool 108 onto the stator tooth by sliding the wound concentrated coil including coil endcaps 112 across coil dismounting end 168 onto the stator tooth.

In the illustrated example, coil endcap 112 includes wire guide grooves 220, a pair of wire routing posts 224a and 224b, coil retainer 228 and a pair of slot liner cutouts 232 (one slot liner cutout 232 along a side of coil endcap 112 and visible in FIG. 6B; and a second slot liner cutout 232 on an opposite side of coil endcap 112 and not visible in FIG. 6B). Coil endcap 112 may include any suitable number of wire guide grooves 220. For example, the number of wire guide grooves 220 may be selected based on the number of turns of wire used for winding the concentrated coil. Wire guide grooves 220 may assist in the placement of the wire during the winding process. Wire guide grooves 220 may enable precise and repeatable coil winding reducing or eliminating the need for segmenting the stator core.

Wire routing posts 224 may be located at proximal end 212. Wire routing posts 224 may have any suitable design to enable routing of the leads of the concentrated coil after the winding process is completed. In the illustrated example, wire routing posts 224 are formed as pillar-shaped structures. After the winding process is completed, the two ends of the wire are removed from wire wrapping posts 172 of spindle 104 to form the leads of the concentrated coil. The leads can be bent around wire routing posts 224 to secure the leads during removal of coil transfer tool 108 from spindle 104 and during transfer of the concentrated coil from coil transfer tool 108 to a stator tooth. In alternative embodiments, coil endcap 112 does not have wire routing posts 224.

Coil retainer 228 may be located at distal end 216. Coil retainer 228 may have any suitable design to retain the wound coil on the coil endcap. In the illustrated example, coil retainer 228 is formed as a raised structure. In other examples, coil retainer 228 may include other structures (e.g., protruding rod-like structures) or may include a differently shaped raised structure. Coil retainer 228 can prevent the concentrated coil from slipping off during removal of coil transfer tool 108 from the winding machine, during transfer of the concentrated coil from coil transfer tool 108 to a stator tooth and during operation of the motor. In alternative embodiments, coil endcap 112 does not have coil retainer 228.

During the winding process, a wire can be wound around the coil body including upper coil endcap 112a, lower coil endcap 112b and pair of slot liners 120 to form the concentrated coil. Coil endcaps 112 and slot liners 120 can collectively provide electrical insulation between the concentrated coil and the stator tooth after the concentrated coil is transferred to the stator tooth. Coil endcaps 112 can provide insulation at the two axial ends of the stator tooth while slot liners 120 can provide insulation along the length of the stator tooth.

Slot liner cutouts 232 may have any suitable design to enable positioning of slot liners 120 between the upper coil endcap 112a and the lower coil endcap 112b to form a second pair of opposing sides of the coil body. For example, a side 240 of the second pair of opposing sides of coil body 166 is shown in FIG. 7.

In the illustrated example, each coil endcap 112 includes a pair of slot liner cutouts 232 (only one of which is visible in FIG. 6B). Each slot liner cutout 232 may be formed as a cutout or groove along the edges of coil endcaps 112 that extends between proximal end 212 and distal end 216. The slot liner can be positioned by placing an edge of the slot liner into slot liner cutout 232. When coil transfer tool 108 is removably secured to spindle 104, and upper coil endcap 112a and lower coil endcap 112b are removably mounted on upper coil endcap mount 140 and lower coil endcap mount 144 respectively, the pair of slot liners 120a and 120b are positionable between upper coil endcap 112a and lower coil endcap 112b to form a second pair of opposing sides of the coil body. In alternative embodiments, coil endcap 112 does not have slot liner cutout(s) 232.

Slot liners 120 can be made using any suitable materials that provide electrical insulation. For example, slot liners 120 can include insulation paper in a thickness range typically from 0.05 mm to 1 mm. Thicker slot liners 120 may provide better insulation performance but can reduce the slot fill factor. Thinner slot liners 120 may enable higher slot fill factor but may not provide sufficient level of insulation. In some embodiments, the stator tooth may be insulated (e.g., using an epoxy powder coat) and apparatus 100 may not include slot liners 120.

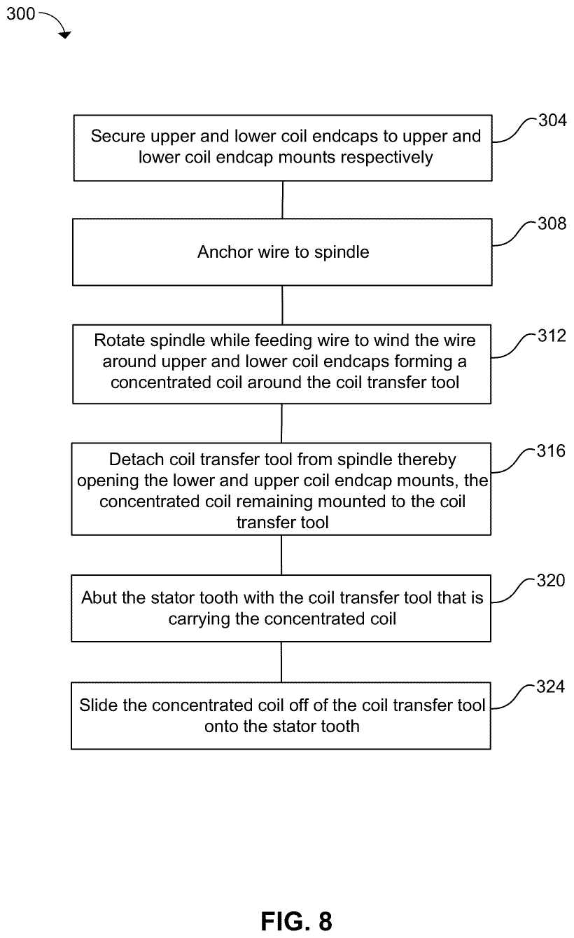

Referring now to FIG. 8, shown therein is a flowchart illustrating an example method 300 of manufacturing a concentrated coil for a stator tooth. Method 300 may be performed, for example, using apparatus 100 and reference is also made below to FIGS. 1 to 7 showing apparatus 100.

At step 304, upper and lower coil endcaps (e.g., upper coil endcap 112a and lower coil endcap 112b) may be secured to upper and lower coil endcap mounts (e.g., upper coil endcap mount 140 and lower coil endcap mount 144) that are defined collectively by a coil transfer tool (e.g., coil transfer tool 108) and a spindle (e.g., spindle 104). The coil transfer tool may be removably secured to the spindle and the spindle may be mounted to a winding machine (e.g., winding machine 10). The winding machine may include a wire guide (e.g., wire guide 18) that can feed wire (e.g., wire 22) to form a concentrated coil (e.g., concentrated coil 26).

As an example, the coil transfer tool may be removably secured to the spindle by bolting the coil transfer tool to the spindle (e.g., using threaded fasteners 134). The upper and lower coil endcaps may be secured to upper and lower coil endcap mounts by applying a compressive force between the coil transfer tool and the spindle. In some examples, the upper and lower coil endcaps may be secured to upper and lower coil endcap mounts using fasteners.

In some examples, a pair of slot liners (e.g., slot liners 120) may be disposed between the upper coil endcap and the lower coil endcap (e.g., by placing opposing edges of each slot liner within the slot liner cutouts (e.g., slot liner cutouts 232) present in the upper coil endcap and the lower coil endcap).

At step 308, a first end of the wire may be anchored to the spindle. For example, the wire may be anchored to a wire wrapping post (e.g., wire wrapping post 172) of the spindle.

At step 312, after the first end of the wire is anchored, the winding machine may rotate the spindle while feeding the wire from the wire guide to wind the wire around the upper and lower coil endcaps. Multiple turns of wire may be wound around the upper and lower coil endcaps thereby forming a concentrated coil around the coil transfer tool. The concentrated coil can include the multiple turns of the wire and the upper and lower coil endcaps. In examples using the pair of slot liners, the multiple turns of the wire are also wound around the pair of slot liners and the concentrated coil also includes the pair of slot liners.

In some examples, the upper and lower coil endcaps include wire guide grooves (e.g., wire guide grooves 220). The multiple turns of the wire may be wound by placing the wire within the wire guide grooves. This may enable precise and repeatable winding.

After the winding process is completed, the wire may be wrapped around a wire wrapping post of the spindle and cut to separate it from the remaining wire in the winding machine. Coil leads may be formed by bending the free ends of the wire around a wire routing post (e.g., wire routing post 224) of the upper or lower coil endcap.

At step 316, the coil transfer tool may be detached from the spindle thereby opening the upper and lower coil endcap mounts. For example, the bolts securing the coil transfer tool to the spindle may be removed to detach the coil transfer tool from the spindle. The concentrated coil, including the windings, the upper coil endcap, the lower coil endcap and the slot liners (if any), may remain mounted to the coil transfer tool.

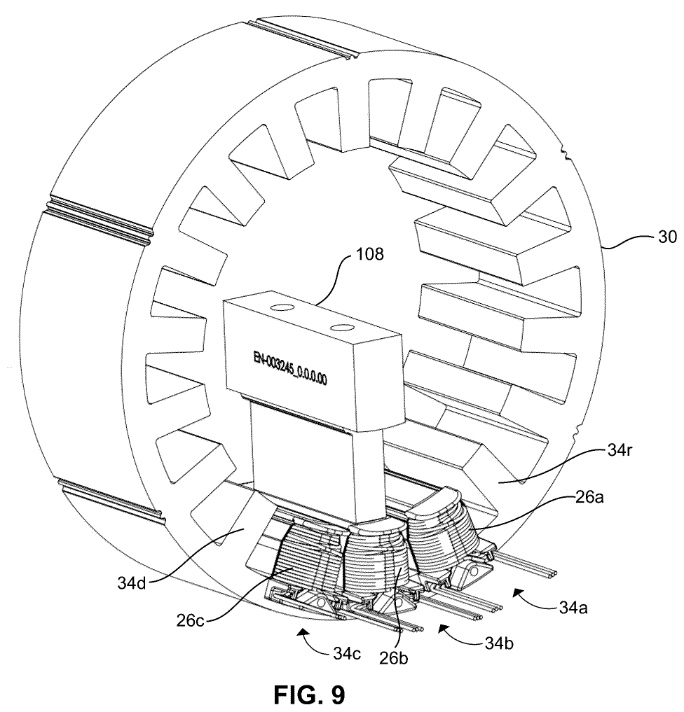

At step 320, a stator tooth may be abutted with the coil transfer tool that is carrying the concentrated coil. For example, a stator tooth of a switched reluctance motor may be abutted with the coil transfer tool that is carrying the concentrated coil. Referring now to FIG. 9, shown therein is a perspective view of a stator tooth 34b of a stator 30 abutting coil transfer tool 108. Stator 30 may include multiple stator teeth (e.g., 34a-34r).

Referring back to FIG. 8, at step 324, the concentrated coil may be slid off of the coil transfer tool onto the stator tooth that is abutting the coil transfer tool. For example, FIG. 9 shows a concentrated coil 26b that has been transferred from coil transfer tool 108 to stator tooth 34b by sliding concentrated coil 26b off coil transfer tool 108 onto abutting stator tooth 34b. Concentrated coils may be transferred to the remaining stator teeth in a similar manner (e.g., FIG. 9 shows concentrated coils 26a and 26c that have been transferred to stator teeth 34a and 34c).

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto. The scope of the claims should not be limited by the preferred embodiments and examples, but should be given the broadest interpretation consistent with the description as a whole.

### Items

Item 1: Concentrated coil manufacturing apparatus for transfer to a stator tooth, the apparatus comprising: a spindle comprising a spindle winding machine mount and a transfer tool mount; and a coil transfer tool extending from a spindle mounting end to a transfer tool distal end, the coil transfer tool having a coil carrier and a crown, the coil carrier extending from the crown towards the spindle mounting end, the spindle mounting end of the coil transfer tool being removably securable to the spindle at the transfer tool mount, when the coil transfer tool is removably secured to the spindle at the transfer tool mount, the coil transfer tool and the spindle collectively define upper and lower coil endcap mounts that are closed in that each endcap mount includes a proximal portion defined by the spindle joined to a distal portion defined by the coil transfer tool, and when the coil transfer tool is separated from the spindle, the upper and lower coil endcap mounts are opened in that the distal portions of the upper and lower coil endcap mounts are separated from the proximal portions of the upper and lower coil endcap mounts respectively to define a coil dismounting end on the coil transfer tool.

Item 2: The apparatus of any preceding item, wherein the spindle further comprises a plurality of wire wrapping posts.

Item 3: The apparatus of any preceding item, wherein the spindle winding machine mount comprises a machine interface and one or more apertures.

Item 4: The apparatus of any preceding item, wherein the transfer tool mount comprises one or more fastener receptacles to accept corresponding fasteners for removably securing the coil transfer tool to the spindle.

Item 5: The apparatus of any preceding item, wherein the transfer tool mount comprises a recessed portion to receive the spindle mounting end of the coil transfer tool.

Item 6: The apparatus of any preceding item further comprising an upper coil endcap mountable to the upper coil endcap mount, and a lower coil endcap mountable to the lower coil endcap mount.

Item 7: The apparatus of any preceding item, wherein when the upper and lower coil endcap mounts are closed and the upper and lower coil endcaps are mounted to the upper and lower endcap mounts respectively, the upper coil endcap and the lower coil endcap form a first pair of opposing sides of a coil body.

Item 8: The apparatus of any preceding item, wherein each of the upper coil endcap and the lower coil endcap have a plurality of wire guide grooves.

Item 9: The apparatus of any preceding item, wherein the upper coil endcap has a pair of wire routing posts at a proximal end of the upper coil endcap.

Item 10: The apparatus of any preceding item, wherein each of the upper coil endcap and the lower coil endcap has a coil retainer at a distal end of the coil endcap.

Item 11: The apparatus of any preceding item, wherein each of the upper coil endcap and the lower coil endcap has a resistivity greater than 1010 ohm-m at 20° C.

Item 12: The apparatus of any preceding item further comprising a pair of slot liners, wherein when the upper and lower coil endcap mounts are closed and the upper and lower coil endcaps are mounted to the upper and lower endcap mounts respectively, the pair of slot liners are mountable between the upper coil endcap and the lower coil endcap to form a second pair of opposing sides of the coil body.

Item 13: The apparatus of any preceding item, wherein each of the upper coil endcap and the lower coil endcap has a pair of slot liner cutouts for positioning the pair of slot liners.

Item 14: The apparatus of any preceding item, wherein each slot liner of the pair of slot liners has a thickness in a range from 0.05 mm to 1 mm.

Item 15: A method of manufacturing a concentrated coil for a stator tooth, the method comprising: securing upper and lower coil endcaps to upper and lower coil endcap mounts, the upper and lower coil endcap mounts defined collectively by a coil transfer tool and a spindle, the coil transfer tool removably secured to the spindle; anchoring wire to the spindle; after said anchoring, rotating the spindle while feeding the wire to wind the wire around the upper and lower coil endcaps thereby forming a concentrated coil around the coil transfer tool, the concentrated coil including a plurality of turns of the wire and the upper and lower coil endcaps; detaching the coil transfer tool from the spindle thereby opening the upper and lower coil endcap mounts, the concentrated coil remaining mounted to the coil transfer tool; abutting the stator tooth with the coil transfer tool that is carrying the concentrated coil; and sliding the concentrated coil off of the coil transfer tool onto the stator tooth that is abutting the coil transfer tool.

Item 16: The method of any preceding item, further comprising, prior to said securing, removably securing the coil transfer tool to the spindle with at least one fastener.

Item 17: The method of any preceding item, wherein said securing comprises compressing the upper and lower coil endcaps between the coil transfer tool and the spindle.

Item 18: The method of any preceding item, wherein said anchoring comprises anchoring the wire to a wire wrapping post of the spindle.

Item 19: The method of any preceding item, wherein said winding comprises aligning the wire into wire guide grooves of the upper and lower coil endcaps.

Item 20: The method of any preceding item further comprising, after said forming a concentrated coil, bending a free end of the wire around a wire routing post of the upper coil endcap.

Item 21: The method of any preceding item, wherein said securing upper and lower coil endcaps to upper and lower coil endcap mounts comprises positioning a pair of slot liners between the upper coil endcap and the lower coil endcap, said winding comprises winding the wire around the pair of slot liners, and the concentrated coil further comprises the pair of slot liners.

Item 22: The method of any preceding item, wherein each of the upper coil endcap and the lower coil endcap has a pair of slot liner cutouts, and said positioning the pair of slot liners comprises placing opposing edges of each slot liner within the slot liner cutouts of the upper coil endcap and the lower coil endcap.

Item 23: The method of any preceding item, wherein said abutting the stator tooth with the coil transfer tool comprises abutting a stator tooth of a switched reluctance motor with the coil transfer tool.

We claim:

1. Concentrated coil manufacturing apparatus for transfer to a stator tooth, the apparatus comprising:
a spindle comprising a spindle winding machine mount and a transfer tool mount; and
a coil transfer tool extending from a spindle mounting end to a transfer tool distal end, the coil transfer tool having a coil carrier and a crown, the coil carrier extending from the crown towards the spindle mounting end,
the spindle mounting end of the coil transfer tool being removably securable to the spindle at the transfer tool mount,
when the coil transfer tool is removably secured to the spindle at the transfer tool mount, the coil transfer tool and the spindle collectively define upper and lower coil endcap mounts that are closed in that each endcap mount includes a proximal portion defined by the spindle joined to a distal portion defined by the coil transfer tool, and
when the coil transfer tool is separated from the spindle, the upper and lower coil endcap mounts are opened in that the distal portions of the upper and lower coil endcap mounts are separated from the proximal portions of the upper and lower coil endcap mounts respectively to define a coil dismounting end on the coil transfer tool.

2. The apparatus of claim 1, wherein the spindle further comprises a plurality of wire wrapping posts.

3. The apparatus of claim 1, wherein the spindle winding machine mount comprises a machine interface with one or more apertures.

4. The apparatus of claim 1, wherein the transfer tool mount comprises one or more fastener receptacles to accept corresponding fasteners for removably securing the coil transfer tool to the spindle.

5. The apparatus of claim 1, wherein the transfer tool mount comprises a recessed portion to receive the spindle mounting end of the coil transfer tool.

6. The apparatus of claim 1 further comprising an upper coil endcap mountable to the upper coil endcap mount, and a lower coil endcap mountable to the lower coil endcap mount.

7. The apparatus of claim 6, wherein when the upper and lower coil endcap mounts are closed and the upper and lower coil endcaps are mounted to the upper and lower endcap mounts respectively, the upper coil endcap and the lower coil endcap form a first pair of opposing sides of a coil body.

8. The apparatus of claim 6, wherein each of the upper coil endcap and the lower coil endcap have a plurality of wire guide grooves.

9. The apparatus of claim 6, wherein the upper coil endcap has a pair of wire routing posts at a proximal end of the upper coil endcap.

10. The apparatus of claim 6, wherein each of the upper coil endcap and the lower coil endcap has a coil retainer at a distal end of the coil endcap.

11. The apparatus of claim 7 further comprising a pair of slot liners,
wherein when the upper and lower coil endcap mounts are closed and the upper and lower coil endcaps are mounted to the upper and lower endcap mounts respectively, the pair of slot liners are mountable between the upper coil endcap and the lower coil endcap to form a second pair of opposing sides of the coil body.

12. The apparatus of claim 11, wherein each of the upper coil endcap and the lower coil endcap has a pair of slot liner cutouts for positioning the pair of slot liners.

13. A method of manufacturing a concentrated coil for a stator tooth, the method comprising:
securing upper and lower coil endcaps to upper and lower coil endcap mounts, the upper and lower coil endcap mounts defined collectively by a coil transfer tool and a spindle, the coil transfer tool removably secured to the spindle;
anchoring wire to the spindle;
after said anchoring, rotating the spindle while feeding the wire to wind the wire around the upper and lower coil endcaps thereby forming a concentrated coil around the coil transfer tool, the concentrated coil including a plurality of turns of the wire and the upper and lower coil endcaps;
detaching the coil transfer tool from the spindle thereby opening the upper and lower coil endcap mounts, the concentrated coil remaining mounted to the coil transfer tool;
abutting the stator tooth with the coil transfer tool that is carrying the concentrated coil; and
sliding the concentrated coil off of the coil transfer tool onto the stator tooth that is abutting the coil transfer tool.

14. The method of claim 13, further comprising, prior to said securing, removably securing the coil transfer tool to the spindle with at least one fastener.

15. The method of claim 13, wherein said securing comprises compressing the upper and lower coil endcaps between the coil transfer tool and the spindle.

16. The method of claim 13, wherein said anchoring comprises anchoring the wire to a wire wrapping post of the spindle.

17. The method of claim 13, wherein said winding comprises aligning the wire into wire guide grooves of the upper and lower coil endcaps.

18. The method of claim 13 further comprising, after said forming a concentrated coil, bending a free end of the wire around a wire routing post of the upper coil endcap.

19. The method of claim 13, wherein:
said securing upper and lower coil endcaps to upper and lower coil endcap mounts comprises positioning a pair of slot liners between the upper coil endcap and the lower coil endcap,
said winding comprises winding the wire around the pair of slot liners, and
the concentrated coil further comprises the pair of slot liners.

20. The method of claim 13, wherein said abutting the stator tooth with the coil transfer tool comprises abutting a stator tooth of a switched reluctance motor with the coil transfer tool.
